(19) United States
(12) Patent Application Publication
(10) Pub. No.: US 2017/0003257 A1
(43) Pub. Date: Jan. 5, 2017

(54) WETNESS INDICATOR WITH TWO COLORANTS AND TWO STABILIZERS

(71) Applicant: The Procter & Gamble Company, Cincinnati, OH (US)

(72) Inventors: Thomas James KLOFTA, Cincinnati, OH (US); Johannson Jimmy TEE, JR., Mason, OH (US); Kristin Hofmann MILLER, Springboro, OH (US); Italo CORZANI, Chieti (IT)

(21) Appl. No.: 15/194,690

(22) Filed: Jun. 28, 2016

Related U.S. Application Data
(60) Provisional application No. 62/186,406, filed on Jun. 30, 2015.

(51) Int. Cl. G01N 31/22; G01N 21/78

(52) U.S. Cl. CPC G01N 31/222; G01N 21/78

(57) ABSTRACT

A wetness indicator comprising a first and second colorant and a first and second stabilizer, wherein the pKa of the first stabilizer is from about two units below to about one unit above the pKa of the first colorant, and wherein the pKa of the second stabilizer is from about two units below to about one unit above the pKa of the second colorant.

### FIELD OF INVENTION

Disclosed are wetness indicator formulations that comprise two colorants and two stabilizers.

### BACKGROUND OF THE INVENTION

Many disposable absorbent articles comprise a wetness indicator. Wetness indicator compositions may comprise a colorant adapted to change in appearance, i.e., appear, disappear, change color, etc., upon contact with liquids such as urine, runny bowel movements, menses, etc., in the absorbent article. The color changing active used in many wetness indicator compositions are pH indicators. However, current pH-based wetness indicators may be unreliable, having issues such as premature triggering during storage and/or colorant leaching issues, plus there are limits as to the variety of beginning and final color options. Therefore, there is a continuing need for simple wetness/fluid indicators that can provide a variety of color options and a continuing need for ways to incorporate such wetness/fluid indicators into absorbent articles.

### SUMMARY OF THE INVENTION

A wetness indicator formulation is provided, comprising a first colorant and a second colorant, and a first stabilizer and a second stabilizer, wherein the pKa of the first stabilizer is from about two units below to about one unit above the pKa of the first colorant, and wherein the pKa of the second stabilizer is from about two units below to about one unit above the pKa of the second colorant.

### BRIEF DESCRIPTION OF THE DRAWINGS

FIG. 1 is a top view of an absorbent article according to an aspect of the invention.

### DETAILED DESCRIPTION OF THE INVENTION

### Definitions

“Absorbent article” refers to devices which absorb and contain body exudates and, more specifically, refers to devices which are placed against or in proximity to the body of the wearer to absorb and contain the various exudates discharged from the body. Absorbent articles may include diapers, training pants, adult incontinence undergarments, feminine hygiene products, breast pads, care mats, bibs, wound dressing products, and the like. As used herein, the term “body fluids” or “body exudates” includes, but is not limited to, urine, blood, vaginal discharges, breast milk, sweat and fecal matter.

As used herein, the term “colorant” refers to any dye, ink, pigment, inks that comprise dyes or pigments, pH indicators, metal indicators, oxidation or reduction indicators, solvatochromic colorants, biological colorant indicators that change color upon contact with a biological component of an exudates, or any material that has the effect of changing its color or the color of its environment, or any combination thereof.

As used herein, the term “permanent colorant” refers to a colorant that maintains its color independent of environmental factors or one that does not change its color under any circumstance, such as a pH change or exposure to a liquid or specific components of the liquid, high humidities, or high or low temperatures.

“Absorbent core” means a structure typically disposed between a topsheet and backsheet of an absorbent article for absorbing and containing liquid received by the absorbent article and may comprise one or more substrates, absorbent polymer material disposed on the one or more substrates, and a thermoplastic composition on the absorbent particulate polymer material and at least a portion of the one or more substrates for immobilizing the absorbent particulate polymer material on the one or more substrates.

“Comprise,” “comprising,” and “comprises” are open ended terms, each specifies the presence of what follows, e.g., a component, but does not preclude the presence of other features, e.g., elements, steps, components known in the art, or disclosed herein.

“Consisting essentially of” is used herein to limit the scope of subject matter, such as that in a claim, to the specified materials or steps and those that do not materially affect the basic and novel characteristics of the subject matter.

“Diaper” refers to an absorbent article generally worn by infants and incontinent persons about the lower torso so as to encircle the waist and legs of the wearer and that is specifically adapted to receive and contain urinary and fecal waste. As used herein, term “diaper” also includes “pants” which is defined below.

A “nonwoven” is a manufactured sheet, web, or batt of directionally or randomly orientated fibers, bonded by friction, and/or cohesion and/or adhesion, excluding paper and products which are woven, knitted, tufted, stitch-bonded incorporating binding yarns or filaments, or felted by wet-milling, whether or not additionally needled. The fibers may be of natural or man-made origin and may be staple or continuous filaments or be formed in situ. Commercially available fibers have diameters ranging from less than about 0.001 mm to more than about 0.2 mm and they come in several different forms: short fibers (known as staple, or chopped), continuous single fibers (filaments or monofilaments), untwisted bundles of continuous filaments (tow), and twisted bundles of continuous filaments (yarn). Nonwoven fabrics can be formed by many processes such as melt blowing, spun bonding, solvent spinning, electrospinning, and carding. The basis weight of nonwoven fabrics is usually expressed in grams per square meter (gsm).

“Pant” or “training pant”, as used herein, refer to disposable garments having a waist opening and leg openings designed for infant or adult wearers. A pant may be placed in position on the wearer by inserting the wearer's legs into the leg openings and sliding the pant into position about a wearer's lower torso. A pant may be preformed by any suitable technique including, but not limited to, joining together portions of the article using refastenable and/or non-refastenable bonds (e.g., seam, weld, adhesive, cohesive bond, fastener, etc.). A pant may be preformed anywhere along the circumference of the article (e.g., side fastened, front waist fastened).

Many wetness indicators comprise a colorant that is a pH indicator, that is, a material that changes color when a pH change occurs. This mechanism of color change where the pH controls the hue of the color is called halochromism. For such materials, the negative logarithm of its acid dissociation constant, or pKa, can be a way to measure or predict at what pH the material's color will change when contacted by an aqueous fluid like urine. Typically, most diaper wetness indicator compositions employ pH indicator colorants that possess pKa values that are acidic and below a value of 7. An example is bromocresol green which has a pKa value around 4.6. For wetness indicator compositions possessing acidic pKa values below 7 like bromocresol green, the pH indicator colorant within the wetness indicator composition will be acidified in its dry state so it is maintained in its free acid form. For bromocresol green, its free acid form color is yellow. Many pH indicator colorants possess a desirable yellow color when they are acidified to a pH below their pKa values. Examples include bromocresol purple, bromocresol green and bromophenol blue which are all yellow in their free acid forms when they are acidified below their pKa values.

A pH indicator used in a wetness indicator may or may not be stabilized with a stabilizer such as an acid stabilizer. The function of the stabilizer is to maintain the desired dry state color of the wetness indicator composition until it is insulted with a body fluid like urine. Thus, the stabilizer will even maintain the desired dry state color of the wetness indicator after the diaper is exposed to high temperatures and humidities. For pH indicator colorants with pKa values below 7, the acid stabilizer helps to insure the pH indicator remains in its acidic, or first color dry state, because the acid stabilizer is more acidic and has a lower pKa than the colorant. If the pKa of the stabilizer is lower than the pKa of the pH indicator colorant, the stabilizer is more acidic than the pH indicator colorant. This lower pKa of the stabilizer versus the pH indicator colorant insures the colorant stays in its acidic dry state within the dry diaper until a color change is triggered by the higher pH urine (and/or other bodily exudates) which has a pKa higher than both the stabilizer and colorant. The rise in pH above the pKa's for both the stabilizer and colorant as caused by the contact with urine allows the free acid form of the colorant to change into its conjugate base form. This conversion to the conjugate base form of the pH indicator colorant molecule results in a color change due to bond rearrangement within the colorant molecule. The aqueous urine with its higher pKa versus both the colorant and stabilizer also solvates the proton from the acid stabilizer rendering it ineffective in maintaining the colorant in its free acid form. During use within a diaper, the wetness indicator is combined with, for example, urine, which has a pH of about 6. After being wetted by the higher pH urine, the pH of the wetness indicator is raised above the pKa of both the pH indicator colorant and the acid stabilizer, thus changing the pH indicator to its second color state. Thus, if the pKa of the pH colorant indicator is higher than the pH of the contacting urine, no color change will occur since the pH of the urine is acidic enough to maintain the free acid form of the pH colorant indicator. If the pKa of the pH colorant indicator is equal to the pH of the contacting urine, half of the colorant molecules will be in the free acid form and the other half will be in the conjugate base form. This results in a color that is a blend of the free acid color state and its conjugate base color. For a dramatic and high contrast color change, the pH of the urine must be at least one unit, and preferable two units, above the pKa of the colorant to cause a visible color change.

It should also be noted that the concentration of the acid stabilizer can play a role in the color change kinetics. As noted, the acid stabilizer functions to keep the colorant in its dry state acid form since the stabilizer is more acidic and has a lower pKa than the colorant. If the wetness indicator composition possesses a very high concentration of the acid stabilizer, the urine may not be able to dissociate and solvate all of the acidic protons from the stabilizer. Thus, no color change may occur after the wetness indicator is contacted with the higher pH urine because the acid stabilizer still possesses protons that can maintain the pH indicator colorant in its free acid form. Thus, one may want to optimize both the acidity of the stabilizer as characterized by its pKa along with the concentration of the stabilizer.

While known wetness indicators may function sufficiently, the color options that are available in such systems are limited due to cost, formulation stability and processability, consumer color preferences, and safety constraints Thus, there is a continuing need for wetness indicators with a variety of color options for both the first and second color states. Even third and fourth color states can be possible for well-designed wetness indicator compositions.

The present invention can meet this need by providing wetness indicators that have more than one colorant, wherein each colorant is stabilized in its first color state with its own stabilizer. Because the first colorant and the first stabilizer may have a similar pKa and the second colorant and the second stabilizer may have a similar pKa, each colorant in the wetness indicator may be maintained (or stabilized) in its first color state until triggered to its second color state by the urine or other exudate. In some cases, the colorants' pKa's may be low and can be stabilized with very acidic stabilizers. In other cases, the pKa's may be high and the colorants can be stabilized with basic stabilizers with high pKa values above 7. In any case, the use of customized stabilizers in the present invention can allow for a much greater variety of colorants that can be utilized in wetness indicator compositions. This use of various combinations of colorants and stabilizers results in a large variety of both dry state and wet state colors for the wetness indicator compositions. With optimum formulation design with multiple colorants and multiple stabilizers, one can even trigger different colors to appear at different times after a body fluid like urine contacts the wetness indicator composition.

In some embodiments of the present invention, a wetness indicator comprises a first stabilizer where its pKa is either at most about one unit above or multiple units below the pKa of the first colorant, and a second stabilizer where its pKa is either at most about one unit above or multiple units below the pKa of the second colorant. As noted, even third and/or fourth colorants and third and/or fourth stabilizers can be incorporated. In some embodiments, the wetness indicator comprises a first and second colorant and a first and second stabilizer, wherein the pKa of the first stabilizer is from about two units below to about one unit above the pKa of the first colorant, and the pKa of the second stabilizer is from about two units below to about one unit above the pKa of the second colorant. In some embodiments, the pKa of the first stabilizer may be from about one unit below to about one unit above the pKa of the first colorant, and the pKa of the second stabilizer may be from about one unit below to about one unit above the pKa of the second colorant. In some embodiments, the pKa's of the two colorants (and stabilizers) may be close, but in other embodiments, the pKa's of the two colorants (and their respective stabilizers) may be identical or at most, about 4 to about 5 units apart. If the pKa's of the colorants are relatively close or identical to one another, it may be possible to stabilize the composition with a single stabilizer. Or where the colorants have widely separated pKa values, a single stabilizer can be used to create an interesting array of different colors to appear as a function of time after contact with a body fluid like urine. For compositions where the pKa's of the colorants are further apart, each colorant will most likely require its own specific stabilizer in order to combine them effectively into the wetness indicator composition. As the pKa's of the pH colorants become further apart, the time difference for each of them to change color upon wetting with a fluid like urine becomes longer. This can be advantageous if one wishes to create different colors at different points in time after the urine contacts the wetness indicator composition.

Currently, many diaper wetness indicators transition from a yellow dry state to a blue-green color after urine contacts the wetness indicator (WI) composition. This is due to the common choice of bromocresol green as the pH indicator colorant in various WI compositions. Bromocresol green is commonly used because its yellow to blue-green color change is well liked by care givers and its pKa of 4.8 is optimum for use in WI compositions. Also, its yellow free acid form is readily soluble in most lipophilic ingredients used in adhesive compositions. This pKa of 4.8 for bromocresol green is ideal since the yellow free acid state of bromocresol green can be stabilized in the dry state by the use of low cost chemicals functionalized with carboxylic acid groups since many molecules possessing carboxylic acid moieties possess pKa's similar or lower than the pKa of bromocresol green. Depending on the chemical structure of the particular carboxylic acid, one can expect its pKa to be in the range of 3 to 5 which is typically acidic enough to convert the bromocresol green colorant into its yellow free acid form. Even though carboxylic acid moieties are ideally suited for a colorant like bromocresol green, they may not be strong enough acids for other pH indicating colorants with pKa values lower and more acidic than bromocresol green. Thus, the acid stabilizer's pKa must be close, or preferably lower than the pKa of the pH indicating colorant in order to form the free acid colored state in the dry state within an absorbent article like a diaper. Preferably, the acid stabilizer is a stronger acid and possesses a lower pKa than the colorant in order to insure that it is completely protonated in its free acid color state. In addition, bromocresol green's pKa of 4.8 is much lower than the average pH of urine such that when wetted with urine, it quickly and efficiently changes to its blue-green color state as the proton is released from the bromocresol green and the conversion into the blue-green conjugate base state takes place. Thus, because its pKa is between the pKa of many carboxylic acid containing molecules and the pH of urine, bromocresol green is an optimum pH indicating colorant with attractive dry and wet state colors. Also, bromocresol green possesses an attractive color change of yellow in its acidic dry state to a blue-green color after it is converted to its conjugate base form after the more alkaline urine contacts the wetness indicator.

Conversely, some consumers would prefer different or additional color choices, for example, a color change of orange in the dry state before the diaper is put on the baby and blue when the baby urinates within the diaper, or yellow in the dry state and purple in the wet state. Here, for this change of yellow to purple, one would think bromocresol purple would be an ideal candidate with its known color change of yellow in its free acid form and purple when it is deprotonated to its conjugate base form. But, bromocresol purple has a higher pKa of 6.3 compared to the pKa of 4.8 for bromocresol green. So although bromocresol purple's higher pKa allows it to be easily stabilized in its yellow dry state with chemicals functionalized with carboxylic acid moieties since they are much more acidic than the bromocresol purple, the bromocresol purple does not easily change to purple upon contact with urine since its pKa is only slightly higher than the average pH of baby's urine. This close proximity of the urine's pH to the pKa of the bromophenol purple results in slow kinetics for the color change of the bromocresol purple and it can take a very long time for it to fully develop a clearly visible dark purple color. And depending on the acidity of the wetness indicator composition, the bromocresol purple may remain protonated and never change to purple in its conjugate base form. Depending on the exact formulation details, the bromocresol purple may never change color or might change color to a dark purple. To achieve the dark purple color of bromocresol purple, one would have to raise the pH one to two units above its pKa value of 6.3. This insures that the bromocresol purple is in its highly conjugated and purple conjugate base form. One might add an alkaline ingredient to the WI composition to increase the pH upon urine contact but this typically degrades and negatively affects the dry state stability of the yellow acidic color. The alkaline additive can leach out, especially in humid environments, to increase the pH and convert the free acid into the purple conjugate base form. As noted, this dry state stability is especially challenging in humid environments where the moisture might solubilize and increase the activity of the added alkaline ingredient. In this case, the increased solubility of the alkaline ingredient could raise the pH above the pKa of the bromocresol purple and pretrigger its color change to purple in the dry state.

The present invention discloses that dry and wet state colors can be formulated if two pH colorants are combined into a single formulation. For example, a wetness indicator may comprise a first and second colorant and also a first and second stabilizer, where the first colorant and the first stabilizer have similar pKa's and the second colorant and second stabilizer have similar pKa's. In some embodiments, the first stabilizer's pKa is from about two units below to about one unit above the pKa of the first colorant, and the second stabilizer's pKa is from about two units below to about about one unit above the pKa of the second colorant. In some embodiments, the pKa of the colorant and stabilizer may be from about 1.5 to about 3.5, while the pKa of the second colorant and stabilizer may be from about 3.0 to about 5.0, in some embodiments from about 3.5 to about 5.5.

For example, the combination of two colorants such as phloxine B acid and the free acid of bromophenol blue can provide either a color change from yellow to purple or orange to purple. This can be accomplished by careful selection of the acid stabilizers for each of the colorants. For the yellow to purple color change, a phosphorous based stabilizer acid like cetyl phosphate has a pKa low enough to acidify both the phloxine with its pKa near 2.9 and the bromophenol blue with its pKa near 4.0. It should be noted that alkyl phosphate stabilizers like cetyl phosphate and stearyl phosphate and cetearyl phosphate can be complex mixtures of multiple molecules. Thus, a cetyl phosphate from a given supplier may contain traces of phosphoric acid, monocetyl phosphate, dicetyl phosphate and tricetyl phosphate. This combination can still be effective in acidifying the colorant because some or all of the trace materials may be more acidic than the colorant. For example, phosphoric acid has a very low pKa value and so a stabilizer containing traces of phosphoric acid can still be very effective in acidifying colorants within the wetness indicator matrix. Further, if the stabilizer is substantially one molecule, meaning at least about 90% one molecule, in some cases at least about 95% one molecule, or in some cases at least about 99% one molecule, the pKa of the stabilizer may be considered to be the pKa of the predominate molecule. Many acid and base stabilizers will be a mixture of multiple acid ingredients or a mixture of multiple base ingredients, and a key property for their proper functioning within the wetness indicator composition is to be either a stronger acid or stronger base respectively than the colorant they are stabilizing. At a pH below their pKa values, the phloxine is colorless and the bromophenol blue is yellow. If the pH is above their pKa values, the phloxine is red and the bromophenol blue is blue such that the mixture of red and blue results in a final purple color in the wet state. Thus, the resulting dry state color is yellow and the resulting wet state color after being insulted with urine is purple for this combination. But, only a low concentration of the phosphorous based acid stabilizer can be used since it is much more acidic than the bromophenol blue while being closer in acidity to the phloxine. If one includes too much of the cetyl phosphate acid stabilizer which may contain traces of phosphoric acid, the urine might not be able to solvate and deprotonate the acid stabilizer. In such a case, there could be enough remaining acidic protons to keep both the phloxine and bromophenol blue in their protonated acid states. Being a strong acid with a pKa(s) lower than both the pKa's of the phloxine and bromophenol blue, this cetyl phosphate acid stabilizer can stabilize both the phloxine and bromophenol blue into their free acid states. As noted, if too much phosphorous based acid is used, the yellow dry state is achieved but the color change to purple after wetting with urine is very slow and the color is faint. This is because the strong phosphorous based acid stabilizer hinders the rise in pH above the pKa of the bromophenol blue. Essentially, the system can be too acidic such that the formation of the conjugate bases is hindered or takes too long of a time period after contact with the body fluid. To achieve the vivid wet state purple color with acceptable kinetics, a low level of the phosphorous based stabilizer acid like Clariant's Cetyl Phosphate (trade name of Hostaphat CC-100) is incorporated along with a carboxylic acid based ingredient for acidification of the bromophenol blue. For a wetness indicator composition containing both colorants of the free acid of phloxine and the free acid of bromophenol blue, an optimum amount of Hostaphat CC-100 stabilizer is around 0.5 to 1.5% by weight. This is equivalent to around 0.05% to 0.15% of elemental phosphorous being contributed from the acid stabilizer. Not being too strong of an acid stabilizer, the carboxylic acid can keep the bromophenol blue colorant acidified in its yellow dry state but it does not hinder the quick color change to purple after wetting with urine for this particular combination of phloxine, bromophenol blue, and the two acid stabilizers. The carboxylic acid based stabilizer is strong enough to maintain the yellow dry state but not so strong as to hinder a rise in pH well above the pKa of the bromophenol blue after contact with baby's urine. The addition of the carboxylic acid based stabilizer also aids in maintaining the yellow dry color if the caregiver exposes the diaper to high humidities and temperatures.

Example 1 shows a wetness indicator composition with a yellow dry state that changes to purple upon contact with baby's urine. For this Example 1, there are multiple acidic stabilizers where the main stabilizer for the free acid of bromophenol blue is the ethylene acrylic acid. The free acid of cetyl phosphate from the Hostaphat cc-100 is a strong enough acid to protonate both the Phloxine B acid into its colorless form and the bromophenol blue into its yellow form. The hydrogenated gum rosin trademarked as Foral AX-E from Eastman Chemicals can also function as both a tackifying agent along with functioning as an acid stabilizer. The Hostaphat CC-100 cetyl phosphate stabilizer is acidic enough to protonate both the Phloxine B free acid and the free acid of bromophenol blue since the pKa of cetyl phosphate is lower than both of the colorants.

| | W/W | | |
|---|---|---|---|
| Example 1—Yellow to Purple | (%) | CAS No. | Function |
| Performathox 450 ethoxylate* | 11.2 | 251553-55-6 | Surfactant |
| Performathox 480 ethoxylate* | 16.7 | 251553-55-6 | Surfactant |
| Foral AX-E [symbol] | 20.5 | 9005-00-9 | Tackifying |
| | | | Agent |
| Irganox 1010^{□} | 1.0 | 1709-70-2 | Anti-Oxidant |
| Ethylene Acrylic Acid^{Ω} | 45.0 | 9010-77-9 & | Stabilizer & |
| | | 79-10-7 | Binding Agent |
| Benzoflex 98-8^{‡} | 3.6 | 20109-39-1 | Plasticizer |
| Hostaphat CC-100^{>} | 0.8 | 3539-43-3 | Stabilizer |
| Tinuvin UV Light Protectants^{∘} | 1.0 | | UV Protectant |
| Bromophenol Blue Free | 0.15 | 115-39-9 | Colorant |
| Acid [symbol] | | | |
| Phloxine B Acid♡ | 0.06 | 18472-87-2 | Colorant |

*Performathox 420 and Performathox 480 as supplied by Baker-Hughes of Houston, TX. [symbol]
Foral AX-E as supplied by Eastman Chemicals of Kingsport, TN.
^{□}Irganox 1010 as supplied by BASF of Florham Park, NJ. .
^{Ω}Ethylene Acrylic Acid as supplied as AC-5120 by Honeywell Inc. of Morristown, NJ
^{‡}Benzoflex 98-8 as supplied by Eastman Chemicals of Kingsport, TN.
^{>}Hostaphat CC-100 as supplied by Clariant Inc. of Charlotte, NC
^{∘}Tinuvin UV light protectants as supplied by BASF of Florham Park, NJ. . [symbol]
Bromophenol Blue free acid as supplied by TCI Chemicals of Portland, OR.
♡Phloxine B Acid as supplied by TCI Chemicals of Portland, OR.

To make an orange to purple color change, one may remove the Hostaphat CC-100 phosphorous based acid stabilizer from the composition shown in Example 1. The phosphorous based acid stabilizer like Clariant's Hostaphat CC-100 has a lower pKa than carboxylic based acid stabilizers like Honeywell's AC-5120 ethylene-acrylic acid polymer and Eastman Chemical's Foral AX-E hydrogenated gum rosin. With only the carboxylic acid based stabilizers, the phloxine colorant is maintained in its reddish conjugate base form since the carboxylic acid based stabilizers are not strong enough to protonate the phloxine colorant into its colorless acidic state. Since the carboxylic acid stabilizers' pKa's are higher than that of the phloxine colorant, they are weaker acids and can't protonate the phloxine into its acidic colorless state. Rather, the phloxine is maintained in its reddish conjugate base state. But even though protonation of the phloxine colorant is not possible since this colorant's pKa is lower than the carboxylic acid stabilizers, the carboxylic acid based stabilizers are stronger acids than the bromophenol blue colorant and can protonate it to its yellow free acid form. Since the combination of yellow from the acidic bromophenol blue and red from the conjugate base state of phloxine results in the secondary color of orange, this combination results in the dry state color of orange. After wetting with urine with its higher average pH of around 6, this particular composition would change to purple since the combination of red from the phloxine colorant and blue from the conjugate base form of the bromophenol blue colorant results in purple.

Example 2 is a wetness indicator composition that changes from an orange dry state color to a purple wet state color since only one stabilizer is employed in the form of Honeywell's AC-5120 ethylene acrylic acid. Because the acid stabilizer is not strong enough to protonate the Phloxine B acid, it remains in its red conjugate base form. But, the ethylene acrylic acid is strong enough to protonate and stabilize the bromophenol blue into its yellow free acid form. The detailed composition is as follows where only one acid stabilizer in the form of the ethylene-acrylic acid AC-5120 is employed.

| | W/W | | |
|---|---|---|---|
| Example 2-Orange to Violet | (%) | CAS No. | Function |
| Performathox 420 ethoxylate* | 11.25 | 251553-55-6 | Surfactant |
| Performathox 480 ethoxylate* | 11.25 | 251553-55-6 | Surfactant |
| Steareth-20 [symbol] | 12.0 | 9005-00-9 | Surfactant |
| Alvinox 100□ | 0.8 | 1709-70-2 | Anti-Oxidant |
| Ethylene Acrylic Acid^{Ω} | 58.92 | 9010-77-9 & | Stabilizer & |
| | | 79-10-7 | Binding Agent |
| Benzoflex 9-88 ^{‡} | 3.5 | 20109-39-1 | Plasticizer |
| 3V S-130^{∘} | 2.0 | | UV-Stabilizer |
| Bromophenol Blue Free Acid [symbol] | 0.21 | 115-39-9 | Colorant |
| Phloxine B Acid ♡ | .07 | 18472-87-2 | Colorant |

*Performathox 420 and Performathox 480 as supplied by Baker-Hughes of Houston, TX. [symbol]
Steareth-20 as supplied as Brij S20 by Croda, Inc. of Edison, NJ.
□Alvinox 100 as supplied by 3V-Sigma Inc. of Georgetown, SC.
^{Ω}Ethylene Acrylic Acid as supplied as AC-5120 by Honeywell Inc. of Morristown, NJ
^{‡} Benzoflex 98-8 as supplied by Eastman Chemicals of Kingsport, TN.
^{∘}3V S-130 as supplied by 3V-Sigma Inc. of Georgetown, SC. [symbol]
Bromophenol Blue free acid as supplied by TCI Chemicals of Portland, OR.
♡ Phloxine B Acid as supplied by TCI Chemicals of Portland, OR.

Another visual property that can result from the incorporation of two colorants within the WI composition is the appearance of two different colors at different times after the initial insult of the baby's urine. For example, the initial dry color may be yellow but after wetting, the first color to appear after approximately 2 minutes would be pink. About 30 minutes after being wetted with urine, a violet color appears. Thus, if the care giver observes the pink color, he or she knows that the baby has just urinated. If they observe the violet color, they know that baby has been wet for at least 30 minutes. Observing the first pink color within 5 minutes of time upon the first urination wetting could be important if the baby is suffering from a skin ailment like a diaper rash. Here, it would be important to change the diaper as quickly as possible to keep the baby's skin dry in order to enhance the healing process.

To make such a two stage color change indicator, it is important for the pKa's of the two colorants to be further apart than that of something like the Phloxine B Acid and the free acid of Bromophenol Blue. Here for the combination of the Phloxine B Acid colorant with the free acid of the Bromophenol Blue colorant, their two pKa's are relatively close to one another such that after wetting with urine, they change to their conjugate base colors in a time frame within a few seconds from one another. This is not the case if Phloxine B Acid is combined with the free acid of the Bromocresol Green colorant. Here with their pKa's being several units apart, the more acidic Phloxine B Acid converts first to its reddish colored conjugate base before the free acid of Bromocresol Green. Being a stronger acid, the Phoxine B free acid gives up its proton more readily than the free acid of Bromocresol Green after being wetted with urine. This results in the initial reddish-pink color from the conjugate base of Phloxine after around two minutes of time. After dilution of the acid content within the WI composition due to longer contact with the urine, the pH ultimately goes up high enough to convert the Bromocresol Green into its blue-green conjugate base after around 30 minutes after being wetted with urine. With the Bromocresol Green in its conjugate base blue-green state and the Phloxine B acid in its reddish-pink conjugate base state, the resulting combination is a violet color after around 30 minutes of time. The composition for this Example 3 is given below where three stabilizers with varying acidities are employed to change the time at which various colors appear after contact with a fluid like urine. The stabilizers include the ethylene acrylic acid (Honeywell's AC-5120) and the free acid of cetyl phosphate (Clariant's Hostaphat cc-100) and the sulfonic acid functionality from the benzophenone-4. Possessing a very strong sulfonic acid moiety, the benzophenone-4 is the strongest acid for this combination. All three of these acid stabilizers are strong enough to protonate the bromophenol blue into its yellow dry state while only the free acid of cetyl phosphate (Hostaphat cc100) and the benzophenone-4 can protonate the Phloxine B into its colorless free acid state. The benzophenone-4 (CAS#4065-45-6) is an interesting compound in that is a very strong sulfonic acid stabilizer along with possessing the ability to absorb UV light. Thus, it can protect the composition from UV light bleaching. Being a very strong acid stabilizer, it can effectively protonate many colorants such that their dry acid state color is very light yellow. Many other sulfonic acid based stabilizers exist and are very effective in protonating very acidic colorants since these sulfonic acid based stabilizers possess very low pKa values. An optimum amount of benzonphenone-4 is around 0.1 to 1.0% by weight which is approximately equivalent to an elemental sulfur content of 0.01 to 0.1% by weight:

| Example 3-Yellow to Pink to | W/W | | |
|---|---|---|---|
| Violet at different times | (%) | CAS No. | Function |
| Performathox 420 ethoxylate ^{*} | 11.3 | 251553-55-6 | Surfactant |
| Performathox 480 ethoxylate ^{*} | 14.3 | 251553-55-6 | Surfactant |
| Steareth-20 [symbol] | 12.4 | 9005-00-9 | Surfactant |
| Alvinox 100□ | 0.8 | 1709-70-2 | Anti-Oxidant |
| Ethylene Acrylic Acid^{Ω} | 56.4 | 9010-77-9 & | Stabilizer & |
| | | 79-10-7 | Binding |
| | | | Agent |
| Benzoflex 9-88 ^{∘} | 3.52 | 20109-39-1 | Plasticizer |
| Benzophenone-4^{‡} | 0.5 | 4065-45-6 | Stabilizer |
| Bromocresol Green Free Acid [symbol] | 0.23 | 76-60-8 | Colorant |
| Phloxine B Acid ♡ | .05 | 18472-87-2 | Colorant |
| Hostaphat CC-100 ^{>} | 0.5 | 3539-43-3 | Stabilizer |

^{*} Performathox 420 and Performathox 480 as supplied by Baker-Hughes of Houston, TX. [symbol]
Steareth-20 as supplied as Brij S20 by Croda, Inc. of Edison, NJ.
□Alvinox 100 as supplied by 3V-Sigma Inc. of Georgetown, SC.
^{Ω}Ethylene Acrylic Acid as supplied as AC-5120 by Honeywell Inc. of Morristown, NJ
^{‡}Benzophenone-4 as supplied as Escalol 577 from Ashland Chemicals..
^{∘} Benzoflex 98-8 as supplied by Eastman Chemicals of Kingsport, TN. [symbol]
Bromocresol Green free acid as supplied by TCI Chemicals of Portland, OR.
♡ Phloxine B Acid as supplied by TCI Chemicals of Portland, OR.
^{>} Hostaphat CC-100 as supplied by Clariant Inc. of Charlotte, NC

Example 4 shows a wetness indicator composition with a yellow dry state that changes to a dark purple upon contact with baby's urine. After being contacted by the baby's urine, the purple color is initially light purple but it darkens to a very dark purple after long times. This is due to stronger acid colorants being turned on first, including the Phloxine B acid color and the free acid of the bromophenol blue. The weaker acid colorants which possess higher pKa's convert to their darker colored conjugate bases at later times but they contribute shades of blue and purple colors to make the final color a very dark purple. The very dark final purple color is due to the inclusion of multiple colorants and multiple stabilizers. For this Example 4, there are multiple acidic stabilizers for the free acid of bromophenol blue and the free acid of bromocresol green and the free acid of bromocresol purple. The acid stabilizers include Honeywell's AC-5120 ethylene acrylic acid stabilizer and Eastman Chemical's Foral AX-E hydrogenated gum rosin acid stabilizer. The free acid of cetyl phosphate from the Hostaphat cc-100 is a strong enough acid stabilizer to protonate the Phloxine B acid into its colorless acid state along with acidifying the bromophenol blue and the bromocresol green and the bromocresol purple. The hydrogenated gum rosin trademarked as Foral AX-E from Eastman Chemicals can also function as both a tackifying agent along with functioning as an acid stabilizer since it possesses acidic moieties within its molecular structure. The Hostaphat CC-100 cetyl phosphate stabilizer is acidic enough to protonate both the Phloxine B free acid and the other three colorants since the pKa's of cetyl phosphate and its trace acid stabilizer impurities like phosphoric acid are lower than all of the four colorants in this Example 4 wetness indicator composition:

| Example 4-Yellow to Dark | W/W | | |
|---|---|---|---|
| Purple | (%) | CAS No. | Function |
| Performathox 450 ethoxylate * | 14.9 | 251553-55-6 | Surfactant |
| Performathox 480 ethoxylate * | 15.0 | 251553-55-6 | Surfactant |
| Foral AX-E [symbol] | 21.0 | 9005-00-9 | Tackifying agent |
| | | | and Stabilizer |
| Irganox 1010 □ | 1.0 | 1709-70-2 | Anti-Oxidant |
| Ethylene Acrylic Acid^{Ω} | 42.5 | 9010-77-9 & | Stabilizer & |
| | | 79-10-7 | Binding Agent |
| Benzoflex 9-88^{‡} | 3.5 | 20109-39-1 | Plasticizer |
| Hostaphat CC-100^{>} | 1.5 | 3539-43-3 | Stabilizer |
| Bromocresol Green Free Acid^{∘} | 0.18 | 76-60-8 | Colorant |
| Bromocresol Purple Free Acid^{∘} | 0.18 | 115-40-2 | Colorant |
| Bromophenol Blue Free Acid [symbol] | 0.18 | 115-39-9 | Colorant |
| Phloxine B Acid ♡ | 0.06 | 18472-87-2 | Colorant |

* Performathox 420 and Performathox 480 as supplied by Baker-Hughes of Houston, TX. [symbol]
Foral AX-E as supplied by Eastman Chemicals of Kingsport, TN..
□ Irganox 1010 as supplied by BASF of Florham Park, NJ..
^{Ω}Ethylene Acrylic Acid as supplied as AC-5120 by Honeywell Inc. of Morristown, NJ
^{‡}Benzoflex 98-8 as supplied by Eastman Chemicals of Kingsport, TN.
^{>}Hostaphat CC-100 as supplied by Clariant Inc. of Charlotte, NC
^{∘}Bromocresol Green free acid as supplied by TCI Chemicals of Portland, OR.
^{∘}Bromocresol Purple free acid as supplied by TCI Chemicals of Portland, OR. [symbol]
Bromophenol Blue free acid as supplied by TCI Chemicals of Portland, OR.
♡ Phloxine B Acid as supplied by TCI Chemicals of Portland, OR.

Another factor in the timing of the individual colorant's color change may be its concentration, and in particular the ratio of concentration of the first colorant to the concentration of the second colorant. This ratio will also affect the hue and chroma for both the initial dry state color along with the final wet state color. Here, the first colorant would be the free acid of bromocresol green or the free acid of bromocresol purple or the free acid of bromophenol blue or combinations thereof and the second colorant would be Phloxine B acid. In general, the ratio of concentration of the first colorant to the second colorant (with the second colorant being the denominator) may be from about 15:1 to about 1:15. In some embodiments, the ratio may be about 10:1 to about 1:10, in some embodiments from about 5:1 to 1:5, in other embodiments about 3:1 to 1:3, and in still other embodiments about 1:1. In some embodiments, the ratio of the concentration of the second colorant to the concentration of the first colorant is about 1:1 to about 10:1 (where the ratios are of second colorant to the first colorant with the first colorant being the denominator).

The examples above include pH indicator colorants that are protonated free acids in the dry state and change to the color of their conjugate bases as a consequence of being contacted by the higher pH of urine. One could also use pH indicator colorants that change color in the alkaline pH range of 7 to 14. In such cases, the wetness indicator may comprise a first basic stabilizer and optionally a second basic stabilizer and even third and fourth basis stabilizers

For example, one could combine aniline blue which is orange in its alkaline state and blue when the pH drops a unit or two below its pKa of around 11.5. Although this orange to blue color change may be attractive in itself, another option is to combine the aniline blue with a pH colorant like Acid Fuchsin which is colorless in its alkaline state and red when its pH is reduced by at least one unit below its pKa of around 13. Thus, when the pH of the system is kept above a pH of 13, both the Acid Fuchsin and Aniline Blue colorants will be in their alkaline color states of colorless and orange, respectively. The colorant's dry state colors are stabilized by using an alkaline stabilizer like tetrabutylammonium hydroxide which possesses a pKa higher than both colorants and is therefore more alkaline than both colorants. Thus, the dry state color for this combination will be orange. Once contacted with the lower pH urine, the acid forms of each pH colorant are formed such that the Acid Fuchsin turns red in color and the Aniline Blue turns blue in color. At the proper ratio of each, the final color will be a combination of blue and red with the resulting wet state color being purple. Example 5 is an example of this alkaline system with both alkaline colorants and alkaline stabilizers:

| Example 5-Yellow to Pink to | W/W | | |
|---|---|---|---|
| Violet | (%) | CAS No. | Function |
| Pearlbond 120 ™ Polyurethane [symbol] | 30.5 | | Binding Agent |
| Performathox 480* | 17.2 | 251553-55-6 | Surfactant |
| Performathox 420* | 12.0 | 251553-55-6 | Surfactant |
| Sylvares ™ TP-2040 Resin□ | 21.7% | 259094-71-8 | Tackifier |
| Polyethylene-imine (PEI) ^{Ω} | 5.8% | | Stabilizer |
| Carbowax 4600 ^{‡} | 4.0 | 20109-39-1 | Plasticizer |
| Cetyl Alcohol^{∘} | 7.0 | | Binding Agent |
| Tetrabutylammonium | 1.0 | 2052-49-5 | Stabilizer |
| hydroxide++ | | | |
| Aniline Blue ♡ | 0.24 | 28983-56-4 | Colorant |
| Acid Fuchsin ♡ | .06 | 3244-88-0 | Colorant |
| Irganox 1010$ | 0.5 | 6683-19-8 | Anti-oxidant |

*Performathox 420 and Performathox 480 as supplied by Baker-Hughes of Houston, TX. [symbol]
Pearlbond 120 Polyurethane as supplied by Lubrizol Inc. of Cleveland, OH.
□Sylvares ™ TP-2040 Resin as supplied by Arizona Chemical of Jacksonville, FL.
^{Ω} Polyethylene-imine as trademarked as Lupasols and supplied by BASF of Florham Park, NJ.
^{‡} Carbowax 4600 as supplied by Dow Chemical Company of Midland, MI.
^{∘}Cetyl Alcohol as supplied by Procter & Gamble Chemicals of Cincinnati, OH.
++Tetrabutylammonium Hydroxide as supplied by Sigma-Aldrich of Milwaukee, WI.
♡ Aniline Blue and Acid Fuchsin as supplied by TCI Chemicals of Portland, OR.
$Irganox 1010 as supplied by BASF of Florham Park, NJ.

Colorants that may be used in the present invention include, but are not limited to, the colorants listed in Table 1. Table 1 also indicates the low pH color, the pH transition range, high pH color, and pKa of each colorant. (Orndorff, W. R.; Purdy, A. C. J. Am. Chem. Soc. 1926, 48, 2216; also in the book “The Sigma Aldrich Handbook of Stains, Dyes, and Indicators,” by Floyd J. Green, 2^{nd} printing published in 1991 by the Aldrich Chemical Company of Milwaukee, Wis. S; See, also, “The Handbook of Acid-Base Indicators,” by R. W. Sabnis and published in 2008 by CRC Press of NY, N.Y.).

| | | Low | pH | High | |
|---|---|---|---|---|---|
| | | pH | Transition | pH | |
| COLORANT | CAS # | Color | Range | Color | pKa |
| Gentian Violet | 548-62-9 | Yellow | 0.0 to 2.0 | Blue- | 1.1 & |
| (Crystal Violet) | | | | Violet | 1.8 |
| Acid Phloxine B | 13473-26-2 | Color- | 1.1 to 3.3 | Purple | 2.9 |
| (free acid form; | | less | | | |
| D&C Red 27) | | | | | |
| Phloxine B | 18472-87-2 | Color- | 1.1 to 3.3 | Purple | 2.9 |
| (sodium salt; | | less | | | |
| D&C Red 28) | | | | | |
| Methyl Violet | 52080-58-7 | Yellow | 0.2 to 1.8 | Purple | 0.8 |
| Malachite Green | 2437-29-8 | Yellow | 0.0 to 2.0 | Green | 1.3 |
| (Acidic pH range) | | | | | |
| Malachite Green | 2437-29-8 | Blue- | 11.6 to 14.0 | Color- | 12.8 |
| (Alkaline pH | | green | | less | |
| range) | | | | | |
| Bromophenol | 115-39-9 | Yellow | 3.0 to 4.6 | Blue | 4.0 |
| Blue Free Acid | | | | | |
| Methyl Orange | 547-58-0 | Red | 3.2 to 4.4 | Yellow | 3.4 |
| Resazurin | 550-82-3 | Orange | 3.8 to 6.5 | Purple | 5.1 |
| Ethyl Red | 76058-33-8 | Red | 4.5 to 6.5 | Yellow | 5.4 |
| Bromocresol | 76-60-8 | Yellow | 3.8 to 5.4 | Blue- | 4.8 |
| Green Free Acid | | | | Green | |
| Quinaldine Red | 117-92-0 | Color- | 1.4 to 3.2 | Red | 2.6 |
| | | less | | | |
| Bromocresol | 115-40-2 | Yellow | 5.2 to 6.8 | Purple | 6.3 |
| Purple Free Acid | | | | | |
| Thymolphthalein | 125-20-2 | Color- | 9.3 to 10.5 | Blue | 9.8 |
| | | less | | | |
| Acid Fuchsin | 3244-88-0 | Red | 12.0 to 14.0 | Color- | 13 |
| | | | | less | |
| Nile Blue | 2381-85-3 | Blue | 9.4 to 11.0 | Purple- | 9.7 |
| | | | | Red | |
| Aniline Blue (also | 28983-56-4 | Blue | 9.4 to 14.0 | Orange | 11.7 |
| known as Methyl | | | | | |
| Blue) | | | | | |
| Indigo Carmine | 860-22-0 | Blue | 11.5 to 14.0 | Yellow | 12.7 |

The wetness indicators of the present invention may comprise from about 0.01% to about 15.0% by weight of colorant(s). The stabilizer, when present is typically employed in compositions at levels which are effective at stabilizing the colorant, from about 0.001% to about 30%, from about 0.1% to about 15%, and also from about 0.5% to about 10%, by weight of the composition.

The wetness indicator may comprise additional colorant(s). Additional suitable fluid colorants include water soluble colorants like direct dyes, acid dyes, base dyes, and various solvent-soluble colorants. Examples of colorants further include, but are not limited to, organic dyes, inorganic pigments, colored macromolecules, colored nanoparticles and materials. In some embodiments, a permanent colorant may be added. Some examples of oil soluble permanent colorants include D&C Yellow No. 11, D&C Red No. 17, D&C Red No. 21, D&C Red No. 27, D&C Red No. 31, D&C Violet No. 2, D&C Green No. 6, FD&C Red 3, D&C Orange No. 4, D&C Orange No. 17, and D&C Orange No. 5. Additional permanent colorants include Pigment Red 146 (CAS#5280-68-2), Pigment Red 122 (CAS#980-26-7), Pigment Orange 16 (CAS#6505-28-8), red beet extract, Manganese Phthalocyanine and other metallized phthalocyanines like copper phthalocyanines and metallized and alkylated porphyrin or phthalocyanines, and beta-carotene and mixtures thereof. Further appropriate additional colorants may include those listed in U.S. Ser. No. 62/147,258.

Appropriate stabilizers include, but are not limited to, those listed in the following Table 2, along with their pKa value(s). Some embodiments may use two, three, four, or more stabilizers. As noted above, the function of acid stabilizers is to keep the pH indicator colorant in a protonated state below its pKa value in the dry wetness indicating state. Thus, since pH indicator colorants have a multitude of different pKa's, a variety of different acids with varying pKa values are required to stabilize these various pH indicator colorants although in certain instances, one very strong acid stabilizer may perform very well with a variety of colorants with pKa values below a value of 7. Alkaline stabilizers may also be required and here the function of the alkaline or basic stabilizer is to keep the pH indicator colorant in its conjugated basic form above its pKa value in the dry wetness indicating state. For the table of acid and alkaline stabilizers below, some of them have more than one pKa value because that particular molecule has more than one acid or alkaline moiety. For example, citric acid possesses three acidic protons with each having different acid strengths. Most frequently, the first pKa is the lowest since the first proton is most frequently the most acidic. Upon release of the first proton, the molecule becomes anionic and that negative charge makes it more difficult for the citric acid molecule to release the second proton. Thus, the second proton is less acidic than the release of the first proton and the second pKa (2) is higher than the first pKa (1). Finally, upon release of two protons from citric acid, the molecule now possesses a negative II charge and this attracts the last remaining positively charged proton such that it is the weakest proton of the three on the citric acid molecule. Thus, citric acid's pKa (3) is larger than its pKa (2) for its second of three protons which is larger than the most acidic pKa (1) proton. In addition, some acid and alkaline stabilizers may be complex mixtures containing molecules with various pKa values. For example and as noted, the cetyl phosphate acid stabilizer as sold as Hostaphat CC-100 from Clariant Inc. can contain traces of phosphoric acid and other acidic components. The key is that the acid or basic stabilizer has one or more components that can stabilize the colorant in its dry state. For acid stabilizers, it must be more acidic and possess a lower pKa than the colorant it must acidify. For basic stabilizers, it must be more alkaline and possess a higher pKa than the colorant so the alkaline colorant is maintained in its basic form in the dry state of the wetness indicator composition.

| | pKa | pKa | pKa | pKa | pKa |
|---|---|---|---|---|---|
| STABILIZER NAME | (1) | (2) | (3) | (4) | (5) |
| Acetamide | 0.6 | | | | |
| Acetic acid | 4.8 | | | | |
| Acetoacetic acid | 3.6 | | | | |
| Adipic acid | 4.4 | 5.4 | | | |
| Alkyl Sulfonic Acid | ~1 | | | | |
| 2-Aminobenzoic acid | 2.1 | 4.9 | | | |
| Ammonia | 9.2 | | | | |
| Aniline | 4.6 | | | | |
| Arginine | 1.8 | 9.0 | 12.5 | | |
| Ascorbic acid | 4.1 | 11.8 | | | |
| Aspartic acid | 2.0 | 3.9 | 10.0 | | |
| Barbituric acid | 4.0 | | | | |
| Benzenesulfonic acid | 0.7 | | | | |
| Benzoic acid | 4.2 | | | | |
| Benzylamine | 9.3 | | | | |
| Betaine | 1.83 | | | | |
| Boric acid | 9.3 | 12.7 | 13.8 | | |
| Butanoic acid | 4.8 | | | | |
| Butylamine | 10.8 | | | | |
| Carbonic acid | 6.4 | 10.3 | | | |
| Catechol | 9.4 | 12.8 | | | |
| Cetyl Phosphate | ~2 | | | | |
| Chloroacetic acid | 2.9 | | | | |
| Citric acid | 3.1 | 4.8 | 6.4 | | |
| m-Cresol | 10.0 | | | | |
| Cysteine | 1.7 | 8.4 | 10.8 | | |
| Decylamine | 10.6 | | | | |
| Dichloroacetic acid | 1.3 | | | | |
| Diethylamine | 10.9 | | | | |
| Diisopropylamine | 11.0 | | | | |
| Dimethylamine | 10.8 | | | | |
| Dimethylglyoxime | 10.7 | 12.0 | | | |
| Dinicotinic acid | 2.8 | | | | |
| Ethanolamine | 9.5 | | | | |
| Ethylamine | 10.6 | | | | |
| Ethylenediamine | 6.8 | 9.9 | | | |
| Ethylenediaminetetraacetic | −0.21 | 1.5 | 2.2 | 3.1 | 6.7 |
| acid (EDTA) | | | | | |
| Ethyleneimine | 8.0 | | | | |
| Formic acid | 3.7 | | | | |
| Fumaric acid | 3.1 | 4.5 | | | |
| L-Glutamic acid | 2.2 | 4.4 | 9.9 | | |
| L-Glutamine | 2.2 | 9.1 | | | |
| L-Glutathione | 2.12 | 3.59 | 8.75 | 9.65 | |
| Glyceric acid | 3.5 | | | | |
| Glycine | 2.3 | 9.8 | | | |
| Glycolic acid | 3.8 | | | | |
| Glyoxylic acid | 3.2 | | | | |
| Heptanedioic acid | 4.7 | | | | |
| Heptanoic acid | 4.9 | | | | |
| Heptylamine | 10.7 | | | | |
| Hexamethylenediamine | 11.9 | 10.8 | | | |
| Hexanoic acid | 4.8 | | | | |
| Hexylamine | 10.6 | | | | |
| Hydrogen chloride | −7 | | | | |
| Hydroquinone | 10.3 | | | | |
| Hydroxylamine | 5.9 | | | | |
| Lactic acid | 3.9 | | | | |
| Maleic acid | 1.9 | 6.3 | | | |
| Malic acid | 3.5 | 5.1 | | | |
| Malonic acid | 2.847 | 5.696 | | | |
| 4-Methylpentanoic acid | 4.8 | | | | |
| Nicotine | 3.1 | 8.0 | | | |
| Nitrous acid | 3.1 | | | | |
| Octadecylamine | 10.6 | | | | |
| Octanedioic acid | 4.5 | | | | |
| Octanoic acid | 4.9 | | | | |
| Oxalic acid | 1.2 | 4.3 | | | |
| Pentanoic acid | 4.8 | | | | |
| Perchloric acid | −10 | | | | |
| p-Periodic acid | 1.5 | 8.3 | | | |
| 1,10-Phenanthroline | 4.8 | | | | |
| Phenol | 10.0 | | | | |
| Phenylacetic acid | 4.3 | | | | |
| Phenylalanine | 2.2 | 9.3 | | | |
| Phenylethylamine | 9.8 | | | | |
| Phenylglycine | 1.8 | 4.4 | | | |
| Phosphoric acid | 2.1 | 7.2 | 12.4 | | |
| m-Phthalic acid | 3.5 | 4.6 | | | |
| o-Phthalic acid | 2.9 | 5.4 | | | |
| p-Phthalic acid | 3.5 | 4.8 | | | |
| Picolinic acid | 1.1 | 5.2 | | | |
| Picric acid | 0.4 | | | | |
| Propanoic acid | 4.9 | | | | |
| Propylamine | 10.6 | | | | |
| 3-Pyridinecarboxylic | 4.9 | | | | |
| acid | | | | | |
| 4-Pyridinecarboxylic | 5.0 | | | | |
| acid | | | | | |
| Pyrimidine | 6.3 | | | | |
| Pyrocatechol | 9.4 | 12.8 | | | |
| Pyrophosphoric | 1.5 | 2.4 | 6.6 | 9.2 | |
| Pyrrolidine | 11.3 | | | | |
| Pyruvic acid | 2.4 | | | | |
| Quinine | 4.1 | 8.5 | | | |
| Quinoline | 4.9 | | | | |
| Resorcinol | 9.3 | 11.1 | | | |
| Salicylic acid | 3.0 | 13.7 | | | |
| Selenic acid | 1.9 | | | | |
| Selenous acid | 2.6 | 8.3 | | | |
| Serine | 2.2 | 9.0 | | | |
| o-Silicic acid | 9.7 | 11.7 | | | |
| m-Silicic acid | 9.7 | 12 | | | |
| Succinic acid | 4.2 | 5.6 | | | |
| Sulfuric acid | −3 | 2.0 | | | |
| Sulfurous acid | 1.9 | 7.2 | | | |
| d-Tartaric acid | 3.0 | 4.4 | | | |
| meso-Tartaric acid | 3.2 | 4.8 | | | |
| Terephthalic acid | 3.5 | | | | |
| m-Toluic acid | 4.3 | | | | |
| o-Toluic acid | 3.9 | | | | |
| p-Toluic acid | 4.4 | | | | |
| Trichloroacetic acid | 0.9 | | | | |
| Triethanolamine | 7.8 | | | | |
| Triethylamine | 10.7 | | | | |
| Trimethylacetic acid | 5.0 | | | | |
| Trimethylamine | 9.8 | | | | |
| Tris(hydroxymethyl)- | 8.1 | | | | |
| aminomethane (tris) | | | | | |
| Tyramine | 9.8 | 10.5 | | | |
| Tyrosine | 2.2 | 9.2 | 10.5 | | |
| Uric acid | 3.9 | | | | |

### Hot Melt Binding Matrix

The wetness indicating compositions that are utilized in this invention comprise a hot melt binding matrix. Processing a hot melt binding matrix involves melting the components together at an elevated temperature, typically from at least about 50° C. to about 170° C., in some embodiments, from about 60° C. to about 130° C., in some embodiments from about 80° C. to about 120° C. In order to be hot melt processable, the wetness indicator composition must be heated to a temperature high enough so as to insure the adhesive flows readily but not so hot so as to cause degradation at an unacceptable rate. Thus, it is common to add an anti-oxidant to hot melt compositions in order to slow down the decomposition rate. It may be difficult to achieve compatibility and stability of such wetness indicating components if processed at room temperature. It may also be difficult under some printing processes to print such compositions onto a substrate. But the present invention's components are melted together at elevated temperatures, and the hot melt liquid is applied and adhered to a substrate while at an elevated temperature to keep the composition in its liquid molten state.

The hot melt binding matrix may comprise binding agents that can be any material that immobilizes the colorant, or combination of colorants, within the matrix to hinder leaching of the colorant(s) into a diaper core or other regions of an absorbent article. To optimize the contrast and vibrancy of the colors, it is much preferred to “lock” the colorant within the matrix before and after contact with a fluid like urine. The binding agents can not only hinder the leaching of the color outside of the matrix, but also aid in binding the entire wetness indicator composition to a component of the absorbent article. For example, the binder can aid in forming a strong bond between the surface of the diaper backsheet and the wetness indicator composition.

There are various materials which may be suitable for use as a binding agent in a hot melt binding matrix for the wetness indicators of the present invention. A number of different polymers and blends of polymers used in hot melt adhesives may be used as the primary binding agent to combine and mix the pH indicating colorants with the acid or alkaline stabilizer and other optional ingredients such as tackifiers, waxes, surfactants, viscosity modifiers, fillers, anti-oxidants, uv stabilizers and other colorants.

Such hot melt polymers, copolymers, terpolymers, and other materials that can function as a binding agent include ethylene vinyl acetates (EVA), polyolefins like low density polyethylene (LDPE) and high density polyethylene (HDPE), atactic polypropylene and polypropylene homopolymers, propylene-ethylene copolymer waxes like Clariant's Licocene PP-1502, oxidized polyethylene like Honeywell's A-C 6702 and A-C 330 and Henkel's Technomelt (REGISTERED™ symbol) line of polyolefins. Polyamides like Henkel's Macromelt (REGISTERED™ symbol here) 6072. Other hot melt components that can function as a binding agent include polymethyl methacrylate, ethylene vinyl acetates (EVA) like Dupont Elvax (trademark symbol) line of EVA's, polymethacrylic acid, polyacrylic acid, ethylene-acrylic acid polymers (EAA) like Honeywell's A-C 5120, fully and partially neutralized salts of the ethylene-acrylic acid copolymers, ethylene-ethyl acetate, polyacrylates, ethylene-vinyl acetate copolymers and oxidized ethylene-vinyl acetate copolymers like Honeywell's A-C 645P, ethylene maleic anhydride copolymers, propylene maleic anhydride copolymers, polyethylene imines (PEI) like BASF's Lupasol (registered trademark symbol), polyurethanes like the polycaprolactan thermoplastic polyurethane named Pearlbond™ 120 from Lubrizol Inc., polyacryl amides, branched copolymers comprising monomeric units derived from acrylic acid and/or quaternary ammonium compounds and/or acrylamide, branched copolymers comprising one or more monomeric units derived from quaternary ammonium compounds, amine compounds, acrylamide compounds, acrylic acid compounds and mixtures thereof at various weight ratios within the polymer, another example is a copolymer of acrylamide reacted with one or more other nonionic monomers, for example non-acrylamide monomers, such as hydroxyalkylacrylate, for example hydroxypropylacrylate, another example is a branched copolymer of acrylamide reacted with bismethyleneacrylamide, a crosslinking agent, that converts a typical linear polyacrylamide into a branched polymeric structure, another copolymer example includes the reaction between a nonionic monomeric unit derived from an acrylamide compound and an anionic monomeric unit derived from acrylic acid or other suitable monomers that could become anionic where examples include anionic monomers selected from the group consisting of: monomers having at least one carboxylic function, for instance α,β-ethylenically unsaturated carboxylic acids or the corresponding anhydrides, such as acrylic, methacrylic or maleic acids or anhydrides, fumaric acid, itaconic acid, N-methacroylalanine, N-acryloylglycine, and their water-soluble salts, monomers that are precursors of carboxylate functions, such as tert-butyl acrylate, which, after polymerization, give rise to carboxylic functions by hydrolysis, monomers having at least one sulfate or sulfonate function, such as 2-sulfooxyethyl methacrylate, vinylbenzene sulfonic acid, allyl sulfonic acid, 2-acrylamido-2-methylpropane sulfonic acid (AMPS), sulfoethyl acrylate or methacrylate, sulfopropyl acrylate or methacrylate, and their water-soluble salts, monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts, and 2-carboxyethyl acrylate (CEA). Not to be bound by theory, but the inclusion of potential anionic moieties within the polymer backbone can aid in decreasing the leaching of a blue cationic form of crystal violet lactone by forming complex between the polymeric anionic and cationic colorant. Other binding agents can form strong associations with colorant molecules through other bonding forces that include van der Waals and hydrogen bonding.

The hot melt may also comprise polymers with a cationic monomeric unit, such as a cationic monomeric unit derived from cationic monomers selected from the group consisting of: N,N-(dialkylamino-w-alkyl)amides of α,β-monoethylenically unsaturated carboxylic acids, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide, α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate, vinylpyridines, vinylamine, vinylimidazolines, monomers that are precursors of amine functions such as N-vinylformamide, N-vinylacetamide, which give rise to primary amine functions by simple acid or base hydrolysis, acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethyl ammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride; 1-ethyl-2-vinylpyridinium or 1-ethyl-4-vinylpyridinium bromide, chloride or methyl sulfate; N,N-dialkyldiallylamine monomers such as N,N-dimethyldiallylammonium chloride (DADMAC); polyquaternary monomers such as dimethylaminopropylmethacrylamide chloride and N-(3-chloro-2-hydroxypropyl)trimethylammonium (DIQUAT) and 2-hydroxy-N¹-(3-(2((3-methacrylamidopropyl)dimethylamino)-acetamido)propyl)-N¹,N¹,N³,N³,N³-pentamethylpropane-1,3-diaminium chloride (TRIQUAT), and. In one example, the cationic monomeric unit comprises a quaternary ammonium monomeric unit, for example a monoquaternary ammonium monomeric unit, a diquaternary ammonium monomeric unit and a triquaternary monomeric unit. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylamino)-acetamido)propyl)-N¹,N¹,N³,N³,N³-pentamethylpropane-1,3-diaminium chloride. Other polymers that can make up the hot melt include polyamines, polypryrroles, polyimidazoles, polycarbonates, polyesters, styrene block copolymers, PVP, PVP/VA copolymer like Ashland Chemical's S-630 PVP/VA, polyacrylamide, polyacryldextran, polyalkyl cyanoacrylate, cellulose acetate, cellulose acetate butyrate, cellulose nitrate, methyl cellulose and other cellulose derivatives, chitosan and chitosan derivatives, chitin and chitin derivatives, nylon 6,10, nylon 6,6, nylon 6, polyterephthalamide and other polyamides, polycaprolactones, polydimethylsiloxanes and other siloxanes, silicone rubbers, aliphatic and aromatic polyesters, polyethylene oxide, polyethylene-vinyl acetate, polyglycolic acid, polylactic acid and copolymers, poly(methyl vinyl ether/maleic anhydride), polystyrene, polyvinyl acetate phthalate, polyvinyl alcohol) polyvinylpyrollidone, copolymers of vinyl pyrrolidone and vinyl acetate, shellac, starch and modified starches, chitosans, fatty alcohols, primary alcohols of long carbon chain lengths of C24 to C50, ethoxylated fatty alcohols, ethoxylated primary alcohols of chain lengths of C24 to C50, fatty acids, and waxes such as paraffinic and microcrystalline, synthetic waxes like polyethylene waxes, natural waxes like beeswax, carnauba wax and mixtures thereof.

In some embodiments, the binding agent may be a hot melt adhesive, in some embodiments, a solvent-based binding matrix. Additional components of a hot melt adhesive binding matrix may include base polymers, tackifiers, waxes, rubbers, solvents, wetting agents, and/or anti-oxidants. Examples of base polymers used in hot melt adhesives may include ethylene-vinyl acetate (EVA) copolymers like those of the Elvax brand name and marketed by DuPont Incorporated; styrenic block copolymers like those from Kraton Incorporated, ethylene/acrylic acid copolymers like the AC brand marketed by Honeywell Incorporated, vinyl pyrrolidone/vinyl acetate copolymers, pyrrolidone homopolymers like those marketed by BASF Incorporated and marketed under the trade name of Luviskol, vinyl pyrrolidone homopolymers, polyamides; kraton polymers, ethylene/acrylic acid copolymers, ethylene-acrylate copolymers; ethylene-vinylacetate-maleic anhydride terpolymer; ethylene-acrylate-maleic anhydride terpolymer; polyolefins such as low density and high density polyethylene, atactic polypropylene, oxidized polyethylene, polybutene-1; amorphous polyolefins like amorphous atactic propylene (APP), amorphous propylene/ethylene (APE), amorphous propylene/butane (APB), amorphous propylene/hexane (APH), and amorphous propylene/ethylene/butane; polyamides; styrene block copolymers (SBC); styrene/acrylic polymers and modified styrene/acrylic polymers; polycarbonates; silicone rubbers; polypyrrole based polymers; thermoplastic elastomers like natural and synthetic polyisoprene, polybutadiene rubber, butyl rubber, chloroprene rubber, ethylene-propylene rubber, epichlorohydrin rubber, polyacrylic rubber, polyether block amides; polymers of acrylates, alkyd resins, amides, amino resins, ethylene co-terpolymer resins such as EVA, epoxy resins, fluoropolymers, hydrocarbon resins, phenols, polyesters, olefins, polyurethanes, silicones and functionalized silicones, polystyrene and polyvinyls.

The binding agent may be employed in compositions at levels which are effective at immobilizing and stabilizing the colorant in its first state, including from about 1% to about 90%, from about 10% to about 75%, and from about 20% to about 65%, by weight of the wetness indicator composition.

The binding matrix may comprise a first and second binding agent. The second binding agent may be any material which may immobilize the colorant when the colorant is in its final color state. This immobilization helps to bind the colorant within the wetness indicator composition to prevent it from leaching to other regions of the diaper such as the diaper core. It should be noted that similar to the first binding agent, the second binding agent can function not only to hinder the leaching of the colorant outside of the wetness indicator composition but can also aid in bonding the entire wetness indicator composition to the material of interest within the absorbent article. For example, the second binding agent may aid in bonding the wetness indicator composition to the backsheet of the diaper. There are various materials which may be suitable for use as an additional binding agent for the wetness indicators of the present invention. For example, the binding agent might be a cationic agent to complex with anionic colorants. Or, the binding agent could be an anionic agent to complex with a cationic colorant like the blue and ring opened form of crystal violet lactone. In one embodiment, a binding agent may be selected from, but are not limited to, the second binding agents disclosed in U.S. Pat. No. 6,904,865 to Klofta.

Tackifiers suitable for hot melt adhesives include, without being limited to, natural resins like the copal type, the damar type, the mastic type, the sandarac type, and mixtures thereof; rosins and their modified derivatives like modified tall oil rosins with Sylvaros PR-R™ from Arizona Chemical™ being an example; polymerized rosins like Sylvaros PR 295™ from Arizona Chemical™, partially dimerized gum rosins like Eastman™ Chemical Inc.'s Poly-Pale™, terpenes and modified terpenes; aliphatic, cycloaliphatic, and aromatic resins like C5 aliphatic resins, C9 aromatic resins, and C5/C9 aromatic/aliphatic resins, acidic rosins and acidic hydrogenated resins like Pinova's Foral AX synthetic resin, Eastman Chemical's fully hydrogenated rosin like its Foral AX-E, alkyl resins, phenolic resins and terpene-phenolic resins like Sylvares™ TP-2040 from Arizona Chemical Inc., hydrogenated hydrocarbon resins and their mixtures.

Waxes suitable for hot melt adhesives include, without being limited to, mineral waxes like paraffin and microcrystalline waxes; polyethylene waxes; polyethylene glycol type waxes like those trademarked as the Carbowax brand; oxidized polyethylene waxes; polymethylene waxes, the bis-stearamides like N,N′-ethylene bis-stearamide trademarked as Acrawax from Lonza Incorporated, highly branched polymer waxes like Vybar™ from Baker Hughes; fatty amide waxes; natural and synthetic waxes like beeswax, soywax, carnuba, ozokerite, ceresin; waxes derived from both the Fisher-Tropsch and Ziegler-Natta processes; water soluble waxes, polyalkylene wax, polyethylene wax, and silicone waxes.

Additional additives for adhesives and hot melt adhesives may include plasticizers, like glyceryl tribenzoate, benzoate esters like Eastman™ Chemicals Benzoflex™ 9-88, alkyl benzoates, C12-15 alkyl benzoate like Alzo's Dermol 25B, C2-C22 alkyl benzoates where the alkyl group is straight or branched or mixtures thereof, alkyl citrates, phthalates, phthalate esters, paraffin oils, and polyisobutylene; UV stabilizers; biocides and antimicrobial preservatives; antioxidants, like BHT, phospites and phosphates; antistatic agents; rosins and their derivatives; pigment, particle and powder wetting agents like polyhydroxystearic acid, polyglyceryl-4 isostearate, hexyl laurate, esters like isopropyl myristate, propylene carbonate, isononyl isononanoate, glyceryl behenate/eicosadioate, trihydroxystearin, C12-15 alkyl benzoate, C2-C22 alkyl benzoates where the alkyl group is straight or branched or mixtures thereof, triethoxycaprylysilane, castor oil; and viscosity modifiers. The wetting agent can be a combination of an ester like isononyl isononanoate and a surfactant like polyhydroxystearic acid. Optionally, solvents like mineral oil, isoparaffins, alkanes like hexane, silicone fluids, esters, alcohols, polyethylene glycols, glycerin, glycols, and water can be added to reduce the viscosity of the composition or to increase the solubility of other ingredients or change other strategic properties of the wetness indicator composition.

The matrix, including both the first and second binding agents, may be employed in wetness indicator compositions at levels which are effective at immobilizing and stabilizing the colorant, including from about 5% to about 95%, from about 10% to about 80%, and from about 25% to about 75%, by weight of the wetness indicator composition.

### Additional Ingredients

Additional ingredients may include, for example, a surfactant, a structural adjunct, and/or solvents. When present, such ingredients are typically employed in the composition at levels that are effective at providing the benefits of the ingredient or ingredients, such as, for example, from about 0.001% to about 50%, from about 0.1% to about 40%, or from about 1% to about 35%, by weight of the composition. Solvents may include a liquid, gel or semi-solid material. The solvent may be water, a thixotropic material, paste, an alcohol, ethylene glycol monobutyl ether, mineral oil, esters, silicone fluids and modified silicone fluids, isoparaffins, alkanes like hexane, toluene, xylenes, low molecular weight polyethylene glycols like PEG-200, glycerin, glycols, a non-flammable solvent, an adhesive material, or other organic species. Preferred non-aqueous solvents may comprise alcohols, acetates, and combinations thereof. The alcohol solvents are preferably selected from the group consisting of iso-propyl alcohol, n-propyl alcohol, ethanol, methanol, and combinations thereof. Likewise, suitable acetate solvents include, but are not limited to, isopropyl acetate, n-propyl acetate, and combinations thereof.

Other suitable solvents that may be effective include water, aqueous detergent solutions, acidic water solutions, alkaline water solutions, isopropanol, ethanol, methyl-ethyl ketone, acetone, toluene, hexane, ethyl 15 acetate, acetic acid (vinegar), cetyl alcohol (fatty alcohol), dimethicone silicone, isopropyl lanolate, myristate, palmitate, lanolin, lanolin alcohols and oils, octyl dodecanol, oleic acid (olive oil), panthenol (vitamin B-complex derivative), stearic acid and stearyl alcohol, butylene glycol and propylene glycol, cyclomethicone (volatile silicone), glycerin, aloe, petrolatum, and so forth. Adhesives that may be useful include, for example, those based on alkyds, animal glues, casein glues, cellulose acetates, cellulose acetate butyrates, cellulose nitrates, ethyl celluloses, methyl celluloses, carboxy methyl celluloses, epoxy resins, furan resins, melamine resins, phenolic resins, unsaturated polyesters, polyethylacrylates, poly-methylmethacrylates, polystyrenes, polyvinylacetates, polyvinylalcohols, polyvinyl acetyls, polyvinyl chlorides, polyvinyl acetate chlorides, polyvinylidene copolymers, silicones, starched based vegetable glues, urethanes, acrylonitrile rubbers, polybutene rubbers, chlorinated rubbers, styrene rubbers, and so forth. Waxes such as, for example, polyolefin waxes, bees waxes, and so forth, and gels such as, for example, glycol dimethacrylate, chitosan, polyacrylates, hydroxypropylcellulose, gelatin, and so forth, may also be useful to effect the color change.

Surfactants that are suitable for the present invention may include, for example, ethoxylated alcohols, fatty alcohols, high molecular weight alcohols, ethoxylated sorbitan esters like Tween™ 40 from Croda, the ethoxylated pareth surfactants like Performathox™ 420 and Performathox™ 450 and Performathox™ 480 and mixtures thereof from Baker Hughes Inc. Inc., ethoxylated esters, glycerol based esters, derivatized polymers and other natural and synthetic waxes or olefinic materials as known in the art; anionic and cationic and amphoteric surfactants, alkoxylated alkylates such as PEG-20 stearate, ethoxylated alcohols like the BRIJ™ materials from Croda Incorporated where Brij™ S-20/Stearth-20 and BrijTML-23 and BrijTMS2/Steareth-2 are examples, end group-capped alkoxylated alcohols, alkoxylated glyceryl and polyglyceryl alkylates such as PEG-30 glyceryl stearate, glyceryl alkylates such as glyceryl stearate, low HLB emulsifiers like sorbitan esters where Span™60 from Croda Inc. is an example, alkoxylated hydrogenated castor oil, alkoxylated lanolin and hydrogenated lanolin, alkoxylated sorbitan alkylates, sugar derived surfactants such as the alkyl glycosides and sugar esters, poloxamers, polysorbates, and sulfo succinic acid alkyl esters like Aerosol™ OT-SE from Cytec is an example. Further examples include nonionic surfactants and amphoteric surfactants and any combination thereof; specific-diethylhexylsodiumsulfosuccinate, available as MONOWET MOE75 from Croda, the sodium dioctyl sulfosuccinate line of surfactants like Aerosol™ OT-100 from Cytec Inc., the phosphate ester surfactants like Croda's Cetyl Phosphate tradenamed as Crodafos MCA or Croda's potassium salt form of Cetyl Phosphate tradenamed as Arlatone MAP160K, or Clariant's Cetyl Phosphate tradenamed as Hostaphat CC-100 and mixtures thereof, the alkyl benzene sulfonic acid and alkyl sulfonic acid surfactants and their corresponding salts like dodecylbenzene sulfonic acid tradenamed by AkzoNobel as Witconic 1298 Soft Acid or the counterpart with branching in the alkyl chain and tradenamed by AkzoNobel as Witconic 1298 Hard Acid, and mixtures thereof. Another example is 4-1-aminoethylphenolpolyoxyethylenefattyethers, polyoxyethylene sorbitan esters, TWEEN, and polyoxyethylene fatty acid esters.

Other suitable surfactants may be neutral block copolymer surfactants, which can be selected from polyoxypropylene-polyoxyethylene block copolymer, poly [poly(ethylene oxide)-block-poly(propylene oxide)]copolymer or propylene glycol-ethylene glycol block copolymer. Suitable neutral polymeric surfactants include TWEEN surfactants, such as TWEEN 20 surfactant, TWEEN 40 surfactant and TWEEN 80 surfactant, and TRITON X-100 surfactant, which are available from Sigma-Aldrich, Incorporated. Other suitable neutral surfactants include polyethylene lauryl ether, polyoxyethylene nonyl phenyl ether, polyoxyethylene oleyl phenyl ether, polyoxyethylene sorbitan monolaurate, polyethylene glycol monostearate, polyethylene glycol sorbitan monolaurate, polyoxyethylenesorbitan monopalmitate, polyoxyethylenesorbitan monostearate, polyoxyethylenesorbitan monooleate, polyoxyethylenesorbitan trioleate, polypropylene glycol sorbitan monolaurate, polyoxypropylenesorbitan monopalmitate, polyoxypropylenesorbitan monostearate, polyoxypropylenesorbitan monooleate, polyoxypropylenesorbitan trioleate, polyalkyne glycol sorbitan monolaurate, polyalkyne glycol sorbitan monopalmitate, polyalkyne glycol sorbitan monostearate, polyalkyne glycol sorbitan monooleate, polyalkyne glycol sorbitan trioleate and mixtures of such neutral surfactants.

The neutral block copolymer based surfactants include PLURONIC series block copolymers, such as PLURONIC P84 or PLURONIC P85 surfactants, which are available from BASF Corporation.

Other suitable neutral block copolymer based surfactants include nonylphenol ethoxylates, linear alkyl alcohol ethoxylate, ethylene oxide-propylene oxide block copolymer, polyoxypropylene-polyoxyethylene block copolymer, polyalkylene oxide block copolymer, polyalkylene oxide block copolymer and propylene glycol-ethylene glycol block copolymer.

It may be desirable to include additional stabilizer(s) when the colorant is a pH indicator and when the absorbent article could be stored under conditions of high humidity and high temperature or ultra intense UV light conditions. The inclusion of a stabilizer and UV light absorber or both is also especially important for new diaper designs where materials and/or chemicals are present that could potentially prematurely activate the color change of the colorant within the ink formulation. Also, the wetness indicator composition may be heated and mixed for long times and at high temperatures where the inclusion of anti-oxidants can slow down the degradation process. Thus, anti-oxidants like Irganox™ 1010 from BASF Inc. or Alvinox 100 from 3V-Sigma Inc. can aid in preventing premature oxidation and degradation of ingredients within the wetness indicating composition. In addition, if the wetness indicator composition might be exposed to ultraviolet light or intense sunlight for long periods of time, a UV stabilizer like Uvasorb™ S130 from 3V-Sigma or Escalol 577 (benzophenone-4, CAS #6628-37-1) from Ashland Chemicals might be added to inhibit photo-bleaching of the wetness indicator composition. Other effective UV stabilizers from BASF include Tinuvin-928 and Tinuvin-770 and Tinuvin-(384-2) and Tinuvin-123 and mixtures thereof. Desiccants can stabilize the composition by trapping free water that could prematurely activate the wetness indicator composition. Examples of suitable desiccants include silica gel, bentonite clays, activated alumina, calcium sulfate, copper(II) sulfate, and magnesium sulfate.

The present invention may include structural adjuncts, such as HLB (hydrophilic lipophilic balance) modifiers, viscosity modifiers, hardening agents, wetting agents, anti-oxidants, anti-leaching aids, and/or colorant solubilizers. Suitable ones may include polymeric thickeners such as block copolymers having polystyrene blocks on both ends of a rubber molecule, the aforementioned copolymers of ethylene and vinyl acetate (EVA), hydrogenated castor oil, polymers, metals salts of fatty acids, silicas and or derivatized silicas, organoclays such as modified and unmodified hectorites and bentonites, modified clays such as modified laponite clays, dibenylidene sorbitol, alkyl galactomannan, aluminium magnesium hydroxide stearate/oil blends and lauroyl glutamic dibutylamide. Hardening agents may include the aforementioned waxes, C 14-22 fatty alcohols, C14-22 fatty acids, C23-60 carboxylic acids, hydrogenated vegetable oils, polymers, sorbitan esters and other high molecular weight esters.

The wetting agent can be a surfactant or a mixture of surfactants. The surfactants can be non-ionic surfactants or ionic surfactants. The ionic surfactants can be either positively charged or negatively charged. The examples of non-ionic surfactants include alkyl poly(ethylene oxide) such as copolymers of poly(ethylene oxide) and poly(propylene oxide) (commercially called Poloxamers or Poloxamines), alkyl polyglucosides such as octyl glucoside and decyl maltoside, fatty alcohols such as cetyl alcohol, oleyl alcohol, cocamide MEA and cocamide DEA. The examples of ionic surfactants include anionic (e.g., based on sulfate, sulfonate or carboxylate anions) surfactants such as SDS, ammonium lauryl sulfate and other alkyl sulfate salts, Sodium laureth sulfate, also known as sodium lauryl ether sulfate (SLES), Alkyl benzene sulfonate, Soaps, or fatty acid salts; and Cationic (e.g., based on quaternary ammonium cations) surfactants such as Cetyl trimethylammonium bromide (CTAB) a.k.a. hexadecyl trimethyl ammonium bromide, and other alkyltrimethylammonium salts, Cetylpyridinium chloride (CPC), Polyethoxylated tallow amine (POEA), Benzalkonium chloride (BAC), Benzethonium chloride (BZT); or Zwitterionic (amphoteric) surfactants such as Dodecyl betaine, Dodecyl dimethylamine oxide, Cocoamidopropyl betaine, Coco ampho glycinate. Alternatively, the wetting agents may also be hydrophilic molecules. The hydrophilic molecules may be small molecules such as sucrose, glucose and glycerol. The hydrophilic molecules may also be polymers such as polyethylene glycol and its copolymers.

### Substrate

In one embodiment of the present invention, the wetness indicator composition of the present invention may be on and/or in a substrate. When present on a substrate, the wetness indicator composition will typically be placed on and/or in a substrate where the substrate will be contacted by a liquid, such as water, urine, menses, blood and the like. The substrate may include, but is not limited to, a structural component, such as woven fabrics, nonwoven fabrics, films, sponges, and combinations thereof. The substrate may comprise synthetic and/or natural materials. In one embodiment of the present invention the optional substrate may be an article in its own right, such as, a continuous nonwoven fabric. In another embodiment of the present invention the substrate to which the wetness indicator composition may be applied or otherwise affixed comprises any one, or a combination of, structural components of an absorbent article, including, but not limited to, the backsheet, topsheet, fasteners, absorbent material, etc., or may be a separate element added or applied to the product. In one embodiment of the present invention the wetness indicator composition is applied to the absorbent article as a whole. In some embodiments, the wetness indicator composition is a single layer. Such a single layer may be applied to a substrate or structural component. In some embodiments, the single-layer formulation may be disposed between the backsheet and the absorbent core, in other embodiments, between the topsheet and the absorbent core.

The wetness indicator composition may be coated over a surface of said substrate as either a) a monochromic color scheme alone, bi-chromic, or multiple colors, b) in various shapes and sizes, c) graphics of patterns or alpha numeric symbols and words, or combinations thereof. The color transition may be from being either a) colored to uncolored, b) uncolored to colored, c) colored to different colored, or d) a combination of a) and b) and c).

The following discussion is for convenience of formulation, but is not intended to limit the type of substrate used herein.

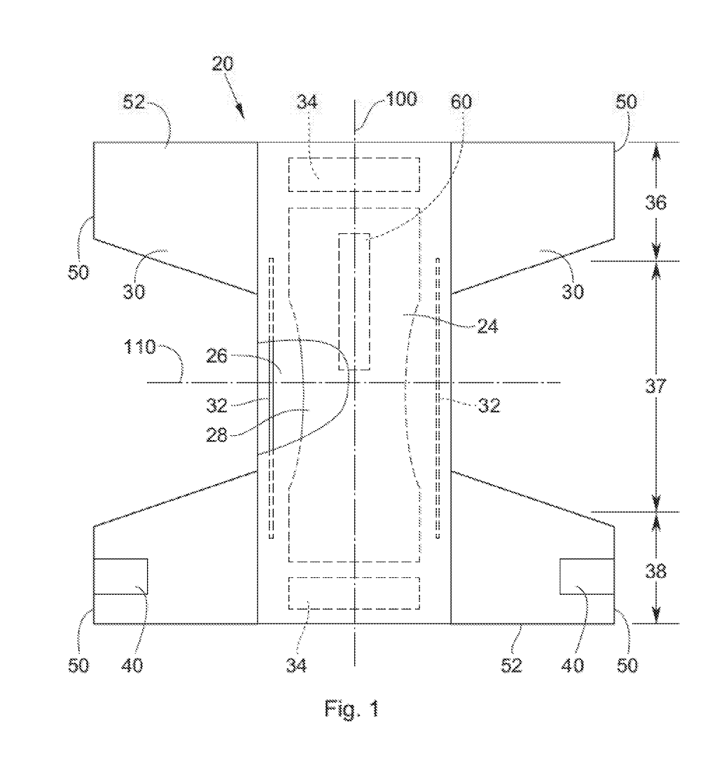

FIG. 1 is a plan view of an absorbent article, in this case a diaper 20, of the present invention in a flat, uncontracted state with portions of the structure being cut away to more clearly show the construction of the diaper. The portion of the diaper 20 that faces a wearer is oriented towards the viewer. As shown in FIG. 1, the diaper 20 comprises a topsheet 24; an outer cover 26; an acquisition layer (not shown), and an absorbent core 28 that is positioned between at least a portion of the topsheet 24 and the backsheet 26. The absorbent article further comprises side panels 30, elasticized leg cuffs 32, elastic waist features 34, and a fastening system generally designated 40. The diaper 20 has a first waist region 36, a second waist region 38 opposed to the first waist region 36, and a crotch region 37 located between the first waist region 36 and the second waist region 38. The periphery of the diaper 20 is defined by the outer edges of the diaper 20 in which longitudinal edges 50 run generally parallel to a longitudinal centerline 100 of the diaper 20 and end edges 52 run between the longitudinal edges 50 generally parallel to a lateral centerline 110 of the diaper 20.

The outermost surface of the backsheet/outer cover 26 forms the garment contacting surface (not shown) of the diaper 20, while the innermost surface of the topsheet 24 forms the body contacting surface (not shown) of the diaper 20. The absorbent articles of the present invention comprise a topsheet 24. In one example, the topsheet 24 is compliant, soft feeling, and non-irritating to the wearer's skin. It can be elastically stretchable in one or two directions. Further, the topsheet is liquid pervious, permitting liquids (e.g., menses, urine, and/or runny feces) to readily penetrate through its thickness. A suitable topsheet can be manufactured from a wide range of materials such as woven and nonwoven materials; apertured or hydroformed thermoplastic films; porous foams; reticulated foams; reticulated thermoplastic films; and thermoplastic scrims. Suitable woven and nonwoven materials may comprise of natural fibers such as wood or cotton fibers; synthetic fibers such as polyester, polypropylene, or polyethylene fibers; or combinations thereof. If the topsheet includes fibers, the fibers may be spunbond, carded, wet-laid, meltblown, hydroentangled, or otherwise processed as is known in the art.

In one embodiment, the backsheet 26 is impervious to fluids (e.g., menses, urine, and/or runny feces) and is manufactured from a thin plastic film, although other flexible liquid impervious materials may also be used. As used herein, the term “flexible” refers to materials which are compliant and will readily conform to the general shape and contours of the human body. The backsheet 26 prevents the exudates absorbed and contained in the absorbent core from wetting articles which contact the absorbent article such as bedsheets, pants, pajamas and undergarments. The backsheet 26 may thus comprise a woven or nonwoven material, polymeric films such as thermoplastic films of polyethylene or polypropylene, and/or composite materials such as a film-coated nonwoven material (i.e., having an inner film layer and an outer nonwoven layer). The backsheet 26 and the topsheet 24 are positioned adjacent a garment surface and a body surface, respectively, of the absorbent core 28.

The articles of the present invention additionally comprise one or more absorbent cores 28. The absorbent core 28 is at least partially disposed between the topsheet and the backsheet and may take on any size or shape that is compatible with the disposable absorbent article. The absorbent core 28 may include any of a wide variety of liquid-absorbent materials commonly used in absorbent articles, such as comminuted wood pulp, which is generally referred to as airfelt. Examples of other suitable absorbent materials for use in the absorbent core include creped cellulose wadding; meltblown polymers including coform; chemically stiffened, modified or cross-linked cellulosic fibers; synthetic fibers such as crimped polyester fibers; peat moss; tissue including tissue wraps and tissue laminates; absorbent foams; absorbent sponges; superabsorbent polymers; absorbent gelling materials (AGM); or any equivalent material or combinations of materials, or mixtures of these. Further useful materials and constructions appropriate for the topsheets, backsheets, outer covers, and absorbent cores described herein may be found in U.S. Ser. No. 14/302,473.

The articles of the present invention may comprise at least one graphic, which refers to images or designs that are constituted by a figure (i.e., a line(s)), a symbol or character, a color difference or transition of at least two colors, or the like. The graphic may have an aesthetic image or design that can provide certain benefits when the absorbent article of the invention is viewed by users or consumers. A variety of graphics can be used in the absorbent articles of the invention.

The article may further comprise at least one wetness indicator 60. A wetness indicator can be located on or against any surface of a component material, including the body contacting surface and the garment contacting surface provided that the wetness indicator 60 remains visible from the exterior of the absorbent article. Non-limiting examples of the component material include the backsheet film/NW, the topsheet, the acquisition layer, the absorbent core, and the barrier leg cuffs. In another embodiment, a wetness indicator 60 is disposed between the absorbent core and the backsheet and in liquid communication with the absorbent core.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wetness indicator comprising:
(a) a first colorant and a second colorant;
(b) a first stabilizer and a second stabilizer;
(c) wherein the pKa of the first stabilizer is from about two units below to about one unit above the pKa of the first colorant; and
(d) wherein the pKa of the second stabilizer is from about two units below to about one unit above the pKa of the second colorant.

2. The wetness indicator of claim 1, wherein the first stabilizer and the second stabilizer are acid stabilizers.

3. The wetness indicator of claim 1, wherein the pKa of the first colorant is from about 1.5 to about 3.5.

4. The wetness indicator of claim 1, wherein the first colorant is phloxine B acid.

5. The wetness indicator of claim 1, wherein the pKa of the second colorant is from about 3.0 to about 5.0.

6. The wetness indicator of claim 1, wherein the second colorant is selected from the group consisting of the free acid of bromophenol blue, the free acid of bromocresol purple, and the free acid of bromocresol green.

7. The wetness indicator of claim 1, wherein the first stabilizer is a phosphorous based acid selected from the group consisting of cetyl phosphate, stearyl phosphate, cetearyl phosphate, dicetyl phosphate, distearyl phosphate, dicetearyl phosphate, phosphorous acid, phosphoric acid, and combinations thereof.

8. The wetness indicator of claim 1, wherein the pKa of the second colorant is from about 3.5 to about 7.0.

9. The wetness indicator of claim 1, further comprising a third and/or fourth colorant selected from the group consisting of the free acid of bromocresol green, the free acid of bromophenol blue, and the free acid bromocresol purple.

10. The wetness indicator of any of the preceding claims, further comprising a third and/or fourth stabilizers.

11. The wetness indicator of claim 1, further comprising a permanent colorant.

12. The wetness indicator of any claim 1, further comprising a hot melt binding matrix.

13. The wetness indicator of claim 12, wherein the hot melt binding matrix comprises one or more selected from the group consisting of a binding agent, a tackifier, a surfactant, a structural adjunct, an anti-oxidant, UV stabilizers, plasticizers, and combinations thereof.

14. An absorbent article comprising the wetness indicator composition of claim 1, wherein the article comprises a backsheet, a topsheet, an absorbent core disposed between the backsheet and the topsheet, wherein the wetness indicator composition is disposed between the backsheet and the absorbent core.

15. The wetness indicator of claim 1, wherein the pKa of the first colorant and the second colorant are about 4 units different, and the ratio of the concentration of the second colorant to the concentration of the first colorant is about 1:1 to about 10:1.

16. The wetness indicator of claim 1, wherein the pKa of the first colorant and the second colorant are at most about 5 units apart.

17. A wetness indicator comprising:
(a) a first colorant and a second colorant;
(b) a first stabilizer and a second stabilizer;
(c) wherein the pKa of the first stabilizer is from about one unit below to about two units above the pKa of the first colorant; and
(d) wherein the pKa of the second stabilizer is from about one unit below to about two units above the pKa of the second colorant.

18. The wetness indicator of claim 17, wherein the first stabilizer and the second stabilizer are basic stabilizers.

19. The wetness indicator of claim 17, wherein the pKa of the first colorant and the first stabilizer is from about 9.0 to about 14.0, and the pKa of the second colorant and the second stabilizer is from about 8.0 to about 13.0.

20. The wetness indicator of claim 17, further comprising a hot melt binding matrix.
